(19) United States
(12) Patent Application Publication
(10) Pub. No.: US 2004/0205559 A1
(43) Pub. Date: Oct. 14, 2004

(54) Method and system for displaying messages in a region associated with textual input of an online education system

(75) Inventor: Thomas M. Sirhall, Littleton, CO (US)

Correspondence Address: LAHIVE & COCKFIELD, LLP., 28 STATE STREET, BOSTON, MA, 02109, US

(73) Assignee: Sun Microsystems, Inc., Palo Alto, CA

(21) Appl. No.: 09/988,836

(22) Filed: Nov. 19, 2001

(51) Int. Cl. G06F 17/24

(52) U.S. Cl. 715/513; 715/501.1

(57) ABSTRACT

The present invention provides applet for creating a popup message when a cursor enters a selected outline area. The applet comprises a receiving module for receiving a textual input. Also, the applet is comprised of a popupmap module for defining at least one outline area in the textual input where a descriptive popup message will be displayed. Further, the applet comprises a cursor module for tracking movements of a cursor and displays the descriptive popup message when the cursor enters the at least one outline area.

### FIELD OF THE INVENTION

The present invention relates generally to software and more particularly to a software facility that generates a descriptive popup for displaying information to a user in an online educational environment.

### BACKGROUND OF THE INVENTION

Some institutions currently offer education courses on-line, either as software that is installed directly on a stand-alone personal computer or software that is installed on a server in a network (e.g., a local area network, or the Internet) for access by multiple client computers. Such on-line courses offer many benefits, including the ability of a student to avoid a commute to a traditional classroom setting, and the ability of a student to participate in a course in a more comfortable setting. The student may proceed at his own pace and may study at times that are convenient for the student.

Conventional online educational courses provide a limited capability for determining how well a student is progressing. Generally, these courses provide some sort of testing of the student. Students are often asked to answer questions and then “self check” their answers. This approach has limited effectiveness.

### SUMMARY OF THE INVENTION

The present invention addresses the above-described limitation by an applet for creating a popup message when a cursor enters a selected area of text. This approach is especially well adapted for use in an on-line educational environment. In one embodiment, the on-line educational environment teaches a student about computer programming and the popup message concerns a section of computer code.

In accordance with one aspect of the present invention, a method for viewing images is practiced in an electronic device in a distributed network. The method includes the step of providing a web page with an embedded software facility that enables a user to create a popup message associated with a textual input to be displayed to the user. A request for the web page is received from a party and, in response, the web page is transmitted to the party.

### BRIEF DESCRIPTION OF THE DRAWINGS

The aforementioned features and advantages, and other features and aspects of the present invention, will become understood with regard to the following description and accompanying drawings; wherein:

FIG. 1 illustrates a distributed environment suitable for practicing the illustrative embodiment of the present invention;

FIG. 2 shows the client system 4 of FIG. 1 in more detail;

FIG. 3 illustrates interactions among components of the illustrative embodiment;

FIG. 4 illustrates a flowchart of the steps used by the edit module 30 of FIG. 3 to edit information in the definition file;

FIG. 5 illustrates a flowchart of the steps used by the popupmap module 28 of FIG. 3 to create outline areas;

FIG. 6 illustrates a flowchart of the steps used by the mouse tracking module 26 of FIG. 3 for tracking movements of the cursor;

FIG. 7 illustrates an example of a user interface in the illustrative embodiment.

### DETAILED DESCRIPTION OF THE INVENTION

The illustrative embodiment of the present invention provides a software facility for creating popup messages in an online educational environment. In particular, the illustrative embodiment allows sections of programming code to be outlined and popups to be displayed regarding the sections of code. This is especially useful for students learning a language such as Java or HTML. In particular, the illustrative embodiment allows sections of programming code to be outlined and popups to be displayed regarding the sections of code. This is especially useful for students learning a language such as JAVA or HTML. The illustrative embodiment may be practiced within a distributed network environment. The distributed network may include several clients and servers. These servers can run on a number of different platforms, including but not limited to UNIX, Windows, Window NT, or Solaris platforms. Those skilled in the art will appreciate that the present invention may be a practiced in a heterogeneous distributed network environment.

The illustrative embodiment of the present invention employs a software facility that may be written, for example, in the JAVA programming language. Nevertheless, those skilled in the art will appreciate that the software facility may alternatively be written in other programming languages. The illustrative embodiment utilizes applet code embedded in documents presented to the user of the online educational system.

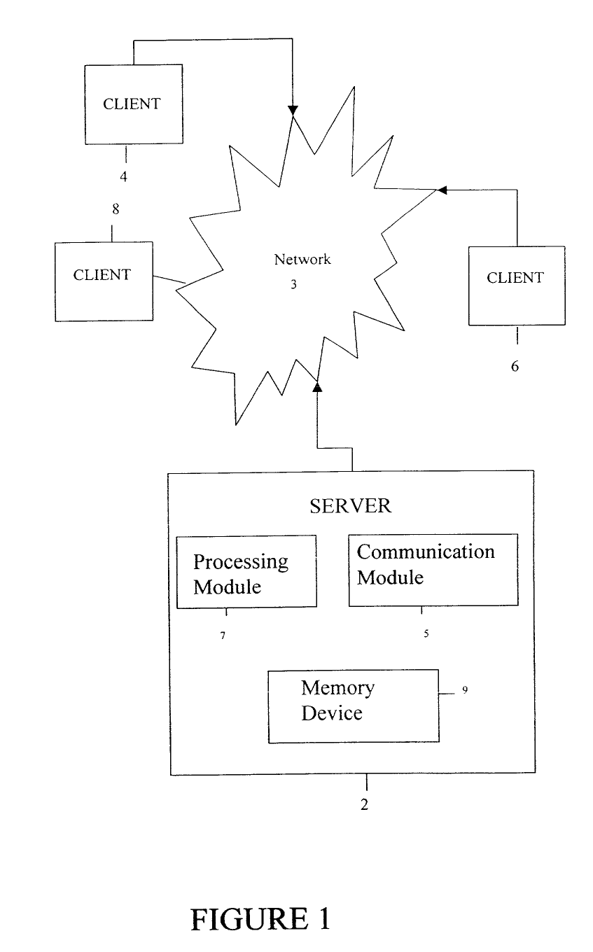

FIG. 1 illustrates a distributed environment I suitable for practicing the illustrative embodiment of the present invention. The distributed environment 1 includes a server 2 connected to a network 3 for storing and transmitting documents and applets to various clients 4, 6, and 8. The documents may be, for instance, HTML documents or XML documents. For purposes of illustration, in the discussion below it is presumed that the documents are HTML documents. The server 2 uses the HTTP protocol or another suitable protocol to communicate with the clients 4, 6, and 8. The server 2 includes a memory device 1 for storing the applets, server side code (such as servlets) and documents. Also, the server 2 has a communication module 5 for processing the requests received from the various clients 4, 6, and 8 and a processing module 7 for processing instructions.

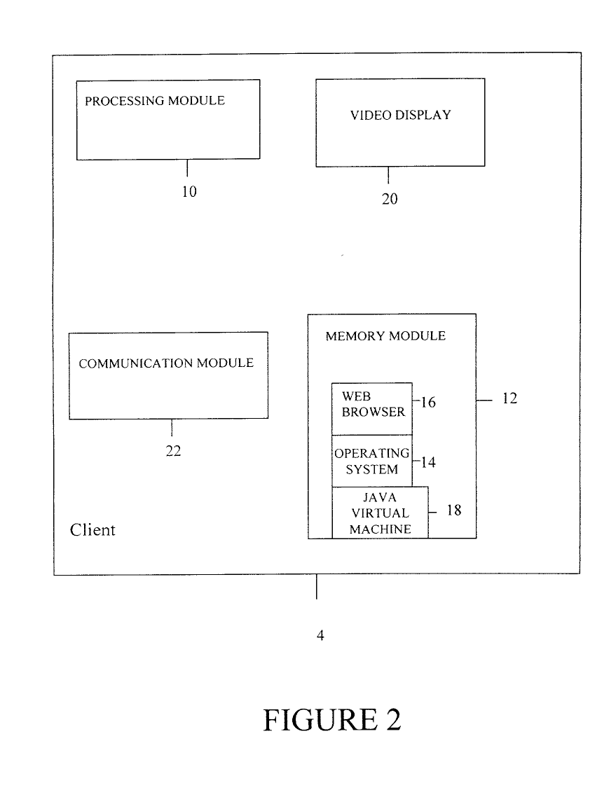

FIG. 2 provides a detailed depiction of the client system 4. Client systems 6 and 8 may be similarly configured The client 4 includes a processing module 10 (such as a microprocessor) for processing instructions and directing activity of the client. The client 4 also has a memory module 12 for storing programs, like an operating system 14 and web browser 16. A Sun Microsystem's HotJava™ browser, or Netscape's Navigator™ browser. The memory module 12 stores a JAVA Virtual Machine™ 18 for executing applets received from the server 2. The web browser 16 facilitates the retrieval and display of documents (such as HTML documents or XML documents) from the server 2. The client 4 includes a video display 20 for displaying video information to a user. The client 4 uses a communication module 22 for communicating remotely with other elements like server 2 or clients 6 and 8. The web browser 16 uses the communication module 22 to communicate with server 2 to retrieve documents with embedded applets. The operating system 14 of client 4 does not need to be the same as the operating system of clients 6 or 8. Similarly, the operating system of server 2 does not need to be the same as the operating systems on clients 4, 6, or 8.

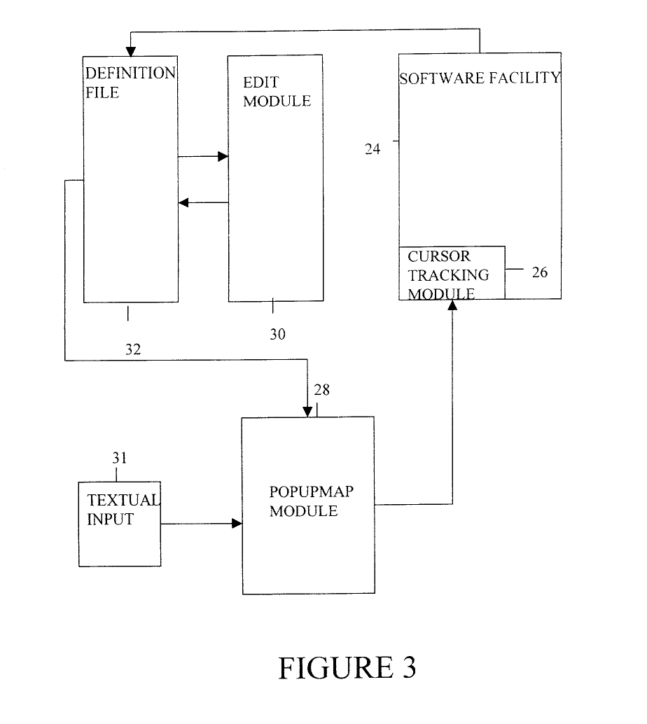

FIG. 3 illustrates interactions among components in the illustrative embodiment. The illustrative embodiment employs a software facility 24 to display a popup message once a cursor enters a selected textual area, such as a section of programming code. The software facility 24 is an applet in the illustrative embodiment and is associated with the online educational environment. The applet may be embedded in an HTML document that is provided by the servers to the client 4, 6, or 8 and rendered by the web browser 16 as part of an online educational course. The software facility 24 provides a portion of the user interface for the online education environment. Also, the software facility retrieves textual input 31, such as programming code in JAVA, HTML or the like. The textual input 31 is downloaded from the server 2 to one of the clients 4, 6, or 8. The inventive software facility 24 is comprised of two functional modules. Once the textual input 31 is downloaded to the clients 4, 6, or 8, the cursor tracking module 26 and popupmap module 28 are invoked. Also, the present invention uses an edit module 30 for editing a definition file 32. The definition file 32 allows one to modify how the software facility 24 will appear to a user. Also, the definition file 32 contains information regarding the location of where the images are stored, user interface characteristics, and information regarding the pace of which the user wants to toggle the images. All of the contents in the definition file 32 are editable. The textual input 31 can be comprised of sections of code or other type of textual information. The popupmap module 28 is used for establishing outlined areas in a textual input 31. The outlines provide borders that delineate the text to which popup applies. The outlines provide that delineate the text to which the popup applies. The cursor tracking module 26 is used to track the movement of the cursor in outlined areas.

The illustrative embodiment uses the software facility 24 to invoke the popupmap module 28 and cursor tracking module 26 to establish areas where specific popup messages will appear in the textual input 31. The software facility 24 reads the information in the definition file 32 to provide for the appearance of how the user will see the images. The software facility 24 has dynamic properties because it configures its appearance and its internal characteristics based on the information in the definition file 32. Thus, allowing the software facility 24 appearance to change.

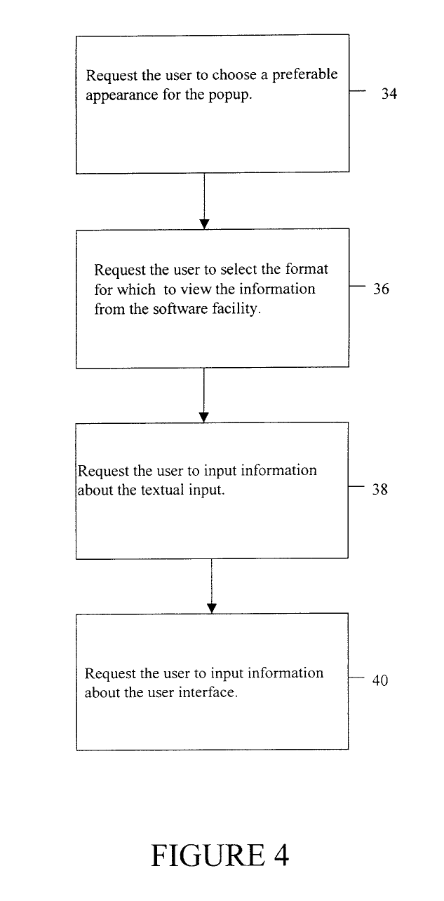

FIG. 4 illustrates a flowchart of the steps performed by the edit module 30 to edit information in the definition file 32. The edit module 30 may be comprised of edit boxes or standard line input for editing information. First, the edit module 30 requests the user to choose which appearance is preferable to the user (step 34). The edit module 30 provides various templates for the user to choose. These templates provide different appearances for popups. The edit module 30 also requests the user to select the format for which to view the information from the software facility 24 (step 36). The edit module 30 allows the user to select the fashion that information is conveyed. For example, the user may select a certain font size to display textual information. The edit module 30 requests that the user input information about the textual input 31 (step 38). In particular, the user inputs the location where the textual input may be stored. Further, the edit module 30 requests the user to input information about the user interface characteristics such as background coloring or border information (step 40).

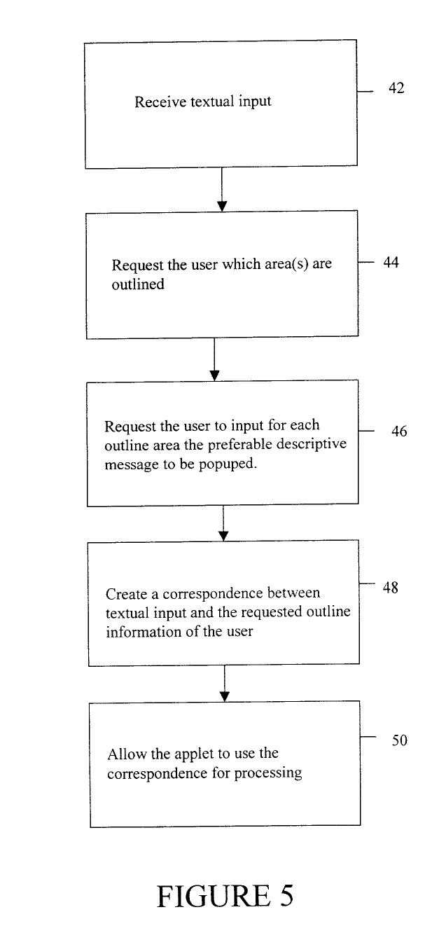

FIG. 5 illustrates a flowchart of the steps used by the popupmap module 28 to create outlined areas. The popupmap module 28 locates where the textual input 31 is stored. The textual input may be stored, for example, on a remote client or on a server. In such an instance, the popupmap module 28 retrieves the textual input 31 from the remote site (step 42). It should be appreciated that the textual input alternatively may be stored locally on a client system. The popupmap module 28 retrieves information regarding where the textual input is located from the definition file 32 (step 42). Once the textual input is retrieved, the popupmap module 28 prompts the user to specify which areas in the textual input are to be outlined (step 44). The textual input is comprised of various sections of text. Thus, the user is requested to select text within these sections that the user wants outlined. The popupmap module 28 requests the user to input the descriptive message to be shown in a popup for each of the selected outlined areas (step 46). The textual input 31 may include a plurality of selected outlined areas and specific descriptive popup message may be provided for each of the outlined areas. The popupmap module 28 creates a correspondence between the textual input 31 and the selected outlined information (step 48). The correspondence is used by software facility 24 to associate selected outlined areas with textual input 31. Afterwards, the popupmap module 28 allows the software facility 24 and the cursor tracking module to use the correspondence for processing purposes (step 50).

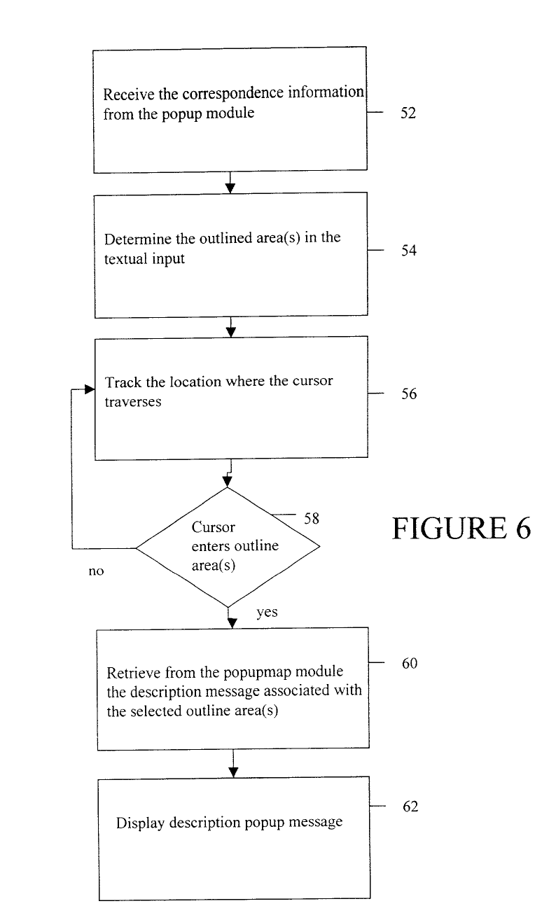

FIG. 6 illustrates a flowchart of the steps performed by the cursor tracking module 26 to track the movement of a cursor. The cursor tracking module 26 receives the correspondence information between the textual input 30 and the users outlined sections from the popupmap module 28 (step 52). Thus, the tracking cursor module 26 has knowledge of the outlined areas in textual input 30. The software facility 24 directs all cursor movement information (such as mouse messages or events) to the cursor tracking module 26. The cursor tracking module 26 has determined where the outlined areas (i.e., in the textual input 30) (step 54). The tracking module 26 tracks the movement and location of the cursor relative to the selected outlined areas in the textual input 30 (step 56). The cursor tracking module 26 determines whether the cursor enters a selected outlined area (step 58). If the cursor enters a selected outlined area, the cursor tracking module 26 retrieved the descriptive popup message associated with the selected outline area from the popupmap module 28 (step 60). Otherwise, the cursor tracking module 26 continues to check the movement and location of the cursor (step 58). Once the cursor tracking module 26 retrieves the descriptive popup message from the popupmap module 28, the descriptive message is displayed in a speech balloon or text box (step 62). The cursor tracking module 26 evaluates every movement of the cursor relative to the correspondence. Thus, allowing the appropriate popup message to be displayed.

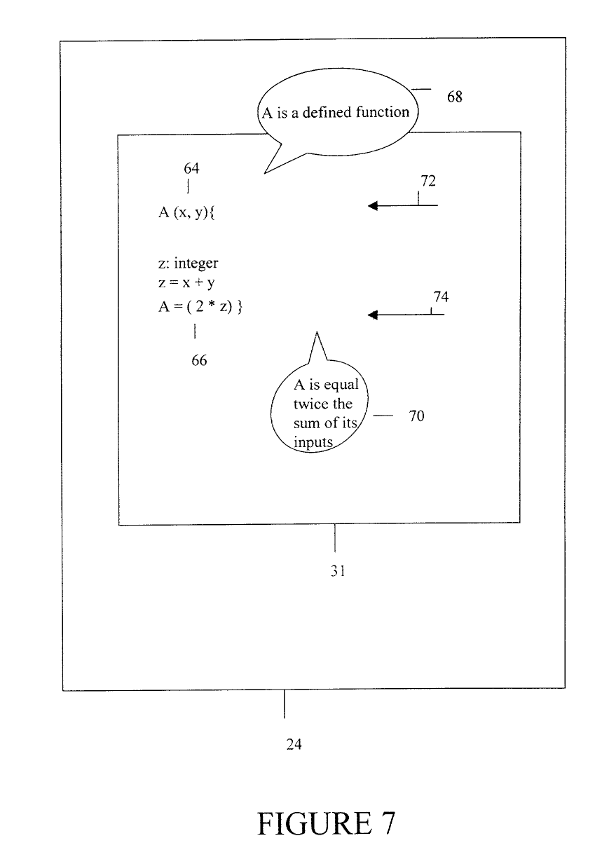

FIG. 7 illustrates an example user interface where popup messages are provided by the illustrative embodiment. The software facility 24 provides the user interface for which the popupmap is contained within. The textual input 31 is a section of code, but the textual input 31 can also be comprised any type of textual input. Within the textual input 31 are several marked outline regions 64 and 66. The user via the popupmap module 28 defines the marked outline regions 64 and 66. As stated above, these marked outline regions 64 and 66 are associated with one or more popup messages. As shown in FIG. 3, the associated popup messages 68 and 70 are associated with the marked outline regions 64 and 66 respectively. When the cursor enters any portion of the marked outline regions 64 and 66, popup messages 68 and 70, respectively, are displayed. When cursor 72 enters marked outline region 64 the popup message 68 is triggered. As stated above, the cursor tracking module 26 tracks the various locations where the cursor moves. The same occurs when the cursor is moved to another location marked as cursor 74 where cursor 74 enters marked outlined region 66. Thus, the popup message 70 is triggered and displayed to the user. The content of the popup messages 68 and 70 are user defined. Basically, the user adds what information should be displayed in a popup message.

The present invention can be used with other various HTML based applications. In particular, the present invention can be use with web learning applications to provide a rich delivery of web learning content. Also, the present invention's uncomplicated approach to creating popup messages provides a useful way of displaying source code demonstrations to a user in an online distributed educational environment. The present invention can be incorporated in any online education environment without much difficulty. Also, the present invention does not require the user to have substantial programming knowledge to use the present invention. The user interface of the present invention can be on included to any online educational environment without substantially changing the code of the online educational system. Thus, allowing the present invention to be user friendly.

Numerous modifications and alternative embodiments of the invention will be apparent to those skilled in the art in view of the foregoing description. Accordingly, this description illustrative only and is for the purpose of teaching those skilled in the art the best mode for carrying out the invention. Details of the structure may vary substantially without departing from the spirit of the invention, and exclusive use of all modifications that come within the scope of the appended claims is reserved. It is intended that the invention be limited only to the extent required by the appended claims and the applicable rules of law.

What is claimed:

1. In an electronic device in a distributed network, a method practiced by an online educational facility comprising the steps of:
providing a web page with an embedded software facility as part of an online educational course, wherein said software facility enables a user to create a popup message associated with text that is to be displayed to the user;
receiving a request for the web page from a party; and
transmitting the web page to the party in response to the request.

2. The method of claim 1, wherein the software facility is an applet.

3. The method of claim 1, wherein the web page is an HTML document.

4. The method of claim 1, wherein the web page is an XML document.

5. The method of claim 1, wherein the software facility is automatically executed after being transmitted to the client.

6. The method of claim 5, wherein the software facility executes in a web browser environment.

7. The method of claim 1, wherein the software facility performs the following steps when the software facility executes:
receiving the text;
defining at least one outlined area in the text where the popup message will appear; and
tracking movement of the cursor and displaying the popup message when the cursor enters the at least one outlined area.

8. The method of claim 7, wherein the text is sections of computer programming code.

9. A medium for use with an electronic device, said medium containing instructions for the electronic device to perform a method that is practiced by an online educational facility, comprising the steps of:
providing a web page with an embedded software facility as part of an online educational course, wherein said software facility enables a user to create a popup message associated with a text that is to be displayed to the user;
receiving a request for the web page from a party; and
transmitting the web page to the party in response to the request.

10. The medium of claim 9, wherein the software facility is an applet.

11. The medium of claim 9, wherein the web page is an HTML document.

12. The medium of claim 9, wherein the web page is an XML document.

13. An electronic device in a distributed network, said electronic device comprising:
a first module for providing a web page with an embedded software facility, wherein said software facility a user to create a popup message associated with a textual input to be displayed to the user;
a second module for receiving a request for the web page from a party; and
a transmitting module for transmitting the web page to the party in response to the request.

14. The electronic device as recited in claim 18 wherein the documents are markup language documents.

15. The electronic device as recited in claim 18 wherein the markup language include executable content for viewing images.

16. The electronic device of claim 18, wherein the software facility is an applet.

17. The electronic device of claim 13, wherein the software facility is automatically executed after being transmitted to the client.

18. The electronic device of claim 17, wherein the software facility executes in a web browser environment.

19. The electronic device of claim 13, wherein the software facility performs the following steps when the software facility executes:
receiving the text;
defining at least one outlined area in the text where the popup message will appear; and
tracking movement of the cursor and displaying the popup message when the cursor enters the at least one outlined area.

20. The electronic device of claim 19 wherein the text is sections of computer programming code.
